(19) United States
(12) Patent Application Publication
(10) Pub. No.: US 2009/0189479 A1
(43) Pub. Date: Jul. 30, 2009

(54) Brush Assembly

(75) Inventors: Shepard L. Hockaday, Benson, NC (US); Dan L. Shull, Fayetteville, NC (US); R. Clay Dunigan, Benson, NC (US); Pimol B. Vonkchalee, Apex, NC (US)

Correspondence Address: MCCARTER & ENGLISH, LLP STAMFORD, FINANCIAL CENTRE , SUITE 304A, 695 EAST MAIN STREET, STAMFORD, CT, 06901-2138, US

(73) Assignee: ENERGY CONVERSION SYSTEMS HOLDINGS, LLC, Dunn, NC (US)

(21) Appl. No.: 12/020,232

(22) Filed: Jan. 25, 2008

(51) Int. Cl. H01R 39/38; H01R 39/59

(52) U.S. Cl. 310/244; 310/253; 310/249

(57) ABSTRACT

A brush assembly is provided that facilitates a longer usable brush life and permits easy brush assembly replacement. The brush assembly includes an arc-shaped brush and a pivot arm, with the mounting end of the arc-shaped brush bound or otherwise mounted with respect to one end of the pivot arm. The end of the pivot arm that is not bound to the arc-shaped brush typically includes a female cylindrical slot for mating with a male shaft that is prefabricated in the motor housing, parallel to the rotor's axis. When the disclosed brush assembly is installed into an electric motor, the pivot arm slot is slidably positioned onto the shaft in the motor housing, enabling the brush assembly to pivot about the shaft on a plane that is perpendicular to the rotor's axis of rotation. A biasing spring force impels the brush assembly to pivot inward toward the rotor in the longitudinal direction of the brush, and maintains the operating end of the arc-shaped brush in contact with the rotating faces of the commutator. A single biasing spring is adapted to act upon both the brush and an interrupter device that is activated when the brush life is exhausted.

### TECHNICAL FIELD

The present disclosure relates generally to the field of electric motors which employ commutators and brushes and, more particularly, to electric motor brush arm assemblies that transfer electric current directly to and from commutators.

### BACKGROUND

Electric motors typically include brushes, electrical leads and a rotor that includes an armature and commutator assembly. The armature is an electromagnet that is made by coiling conducting wires around two or more poles of a metal core, and is fixed to the rotor for rotation. The ends of the armature's conducting wires are fused to the commutator assembly, which generally includes at least one pair of metal plates that are fixed to the rotor and directly opposed to one another. The commutator provides electrical connections between the conducting wires of the armature and the stationary brushes.

Brushes are provided to interact in contact with the rotating commutator. Brushes induce rotation of the motor rotor by transferring current from a power source to the commutator assembly, thereby completing an electric circuit between the armature and the power source, and developing a magnetic field that creates torque on the rotor, which causes the rotor to rotate about its axis. Brushes are fabricated from conductive material, typically carbon or copper-containing powder mixtures, and are electrically linked to a power source by a wire or other form of electrical connection.

Because brushes are designed to remain in contact with the rotating plates of a commutator assembly during operation, they are subject to wear and degradation due to debris, friction, heat and other potentially adverse operating conditions. As brushes wear, arcing, sparking and other harmful effects may occur as the brush face crosses from one commutator plate to another; these effects and others can have a deleterious impact on motor operation. Therefore, in order to maintain proper operation of the motor, brushes must be periodically replaced to assure adequate conduction between the power source and the commutator, and to prevent damage to the commutator.

The present disclosure provides improved brush assemblies, featuring a longer brush life based on geometric advancements over the prior art and enhanced methods for signaling the need for brush replacement. The improved brush assembly's features also enable the assemblies to be easily installed into an electric motor, either during original construction of the motor or as replacements in the field.

### SUMMARY

The present disclosure provides a brush arm assembly that generally delivers a longer brush life and can be installed into electric motors more quickly and easily than standard brush assemblies of the prior art. Indeed, the present invention features several inventive advancements over the prior art which may be practiced alone or in combination, as described herein.

In the field of electric motor design, extending brush life can be accomplished by extending brush lengths. One aspect of the present disclosure is an improved brush assembly geometry that provides for a longer usable brush length. According to the present disclosure, the brush assembly includes an arc-shaped brush and a pivot arm, with the mounting end of the arc-shaped brush bound or otherwise mounted with respect to one end of the pivot arm. The brush generally resembles a long rectangular solid that is curved in the longitudinal direction, and that defines a substantially rectangular cross-sectional area.

The end of the pivot arm that is not bound to the arc-shaped brush typically includes and/or defines a female cylindrical slot for mating with a male shaft that is prefabricated in (or otherwise mounted with respect to) the motor housing, parallel (or substantially parallel) to the rotor's axis. When the disclosed brush assembly is installed into an electric motor, the pivot arm slot is slidably positioned onto the shaft in the motor housing, enabling the brush assembly to pivot about the shaft on a plane that is perpendicular (or substantially perpendicular) to the rotor's axis of rotation. A biasing spring force impels the brush assembly to pivot inward toward the rotor in the longitudinal direction of the brush, and maintains the operating end of the arc-shaped brush in contact with the rotating faces of the commutator.

The arc shape of the disclosed brush improves upon straight-shaped brushes of the prior art in at least three respects. First, the arc shape optimizes brush position on the rotating commutator by maintaining a substantially perpendicular relationship between the brush and the commutator throughout the brush's useful life, thereby ensuring that the surface area of the brush face at its operating end, and the brush's conductive performance, remain approximately constant. Similar brush assemblies with pivot arms in the prior art that feature straight-shaped brushes tend to wear unevenly, such that the brush face surface area changes dramatically throughout brush life. If the brush is not promptly replaced, this effect tends to lead to inefficient motor operation, arcing or sparking, or other harmful effects that can potentially damage the motor.

Additionally, while other brush assemblies in the prior art known as brush boxes or brush holder cartridges maintain a roughly constant surface area in contact with a rotating commutator, the disclosed arc-shaped brush is superior to conventional brush boxes in that it is not subject to grinding and/or friction between the brush and the box or cartridge. The arc-shaped brush of the present disclosure maintains a substantially normal, constant connection with the commutator without the necessity of a box or any framing mechanism. Still further, because electric motor housings are traditionally cylindrically shaped, a brush that features an arced geometry in a circumferential direction around the rotor axis advantageously enables a longer brush length to be stored within the motor housing than a standard straight brush.

Another aspect of the present disclosure is an improved device for sensing the need for brush replacement. More particularly, the present disclosure features an apparatus for halting motor operation, as appropriate, through structural inclusion of a spring-bound interrupter device/mechanism that includes a plunger element that is movably maintained within a deployment hole prefabricated into the arc-shaped brush itself, in the longitudinal direction. An exemplary version of the interrupter device/mechanism of the present disclosure features a non-conductive plunger at its tip; when the arc-shaped brush wears to a predetermined length, the deployment hole is exposed and a biasing spring force will push the plunger element of the interrupter device through the deployment hole and into contact with the rotating faces of the commutator. If biasing spring force on the plunger element exceeds the biasing spring force maintaining the brush face in contact with the commutator, the interrupter device/mechanism pushes the brush face away from the commutator, thereby opening the circuit connecting the power source to the armature. This effect eliminates the magnetic field and, therefore, the torque on the rotor, which automatically stops the motor's rotation.

Unlike other methods for halting motor operation in the prior art, the spring providing the biasing force to the plunger element of the disclosed interrupter device/mechanism is not embedded within the brush itself. Rather, in the present disclosure, the spring that provides the biasing force to the plunger element is maintained physically exterior to the brush, and interacts with the brush through a retaining hole near its mounting end. This structural arrangement reduces the amount of brush length occupied by the interrupter device/mechanism, as compared to embedded interrupter devices in the prior art, and permits more of the brush length to be utilized in motor operation.

Another aspect of the present disclosure is that both the biasing spring force associated with the interrupter device/mechanism and the biasing spring force that maintains the brush operating end in contact with the commutator advantageously originate from a single spring, which is made an integral part of the brush assembly. Because the single spring provides both biasing spring forces and is integral to the brush assembly itself, the brush assembly can be installed into the motor housing more quickly and easily than brush assemblies with pivot arms of the prior art, such as those which necessarily operate using two or more biasing springs.

An additional aspect of the present disclosure relates to the manner in which a physical linkage is established with the electric motor housing. Unlike other brush assemblies featuring pivot arms in the prior art which are durably mounted to their motor housings using caps and screws or other more permanent mounting apparatuses, the disclosed pivot arm includes a cylindrical slot that is configured and dimensioned to mate with a shaft that is fabricated within (or otherwise mounted with respect to) the motor housing. To complete installation, the brush assembly is then pivoted about the shaft until a portion of the pivot arm, referred to herein as a shelf, is situated beneath a hold-down tab that is also fabricated within (or otherwise mounted with respect to) the motor assembly. Once the brush assembly is appropriately positioned with its shelf beneath the hold-down tab, an end of the single spring is physically connected to the motor housing, and the brush assembly is electrically connected to the power supply.

Any form of connection known in the prior art may be used to link the spring with the motor housing and the brush assembly with the power supply, so long as a physical connection is established between the single spring and the motor housing, and an electrical connection is established between the brush and the power source. Preferred connections are established quickly, easily and reliably. Once installed, the disclosed brush assembly is able to pivot about the shaft but is advantageously longitudinally locked in position along the shaft, without the use of standard binding devices, such as caps and screws.

The single spring, shelf and integral cylindrical slot of the present disclosure enable the brush assembly to be installed into electric motors in a few brief steps, neither of which requires the use of any tools. These features simplify the construction of electric motors, which can be assembled in their entirety prior to installing the brush assemblies of the present disclosure. Additionally, the brush assemblies of the present disclosure can be replaced more quickly, easily and reliably than brushes or brush assemblies of the prior art, enabling electric motors to remain in service for longer and more efficient durations.

Further areas of applicability of the present disclosure will become apparent from the drawings and detailed description provided herein. It should be understood that the detailed description and specific examples indicate preferred embodiments of the present disclosure and are intended for illustrative purposes only, but do not limit the scope of the present invention.

### BRIEF DESCRIPTION OF THE DRAWINGS

The subject matter of the present disclosure will become more fully understood from the detailed description and accompanying drawings, wherein:

FIG. 1 is a perspective view of an exemplary brush assembly, according to the present disclosure;

FIG. 2 is a perspective view of an electric motor assembly, with the exemplary brush assembly from FIG. 1 installed into an electric motor housing, showing the contact between the brush face and the commutator;

FIG. 3 depicts an exemplary brush assembly according to the present disclosure at or near the beginning of the useful life of the arc-shaped brush;

FIG. 4 depicts the exemplary brush assembly from FIG. 3, near the end of the useful life of the arc-shaped brush;

FIG. 5A, FIG. 5B and FIG. 5C show an exemplary interrupter device/mechanism installed within an arc-shaped brush of the present disclosure, before actuation, at the moment of actuation, and after actuation of the interrupter device, respectively;

FIG. 6 shows an example of the single spring design that can be used in assemblies of the present disclosure;

FIG. 7 shows a side view of an exemplary brush assembly, according to the present disclosure;

FIG. 8 shows a top view of an exemplary brush assembly, according to the present disclosure;

FIG. 9 is a view of an example of a typical electric motor housing, prior to the installation of a brush assembly according to the present disclosure;

FIG. 10 is a view of a typical electric motor housing during installation of an exemplary brush assembly according to the present disclosure; and

FIG. 11 is a view of a typical electric motor housing with an exemplary brush assembly installed and pivoted into place, with the single spring mounted to the motor housing.

### DETAILED DESCRIPTION OF EXEMPLARY EMBODIMENT(S)

The following descriptions of exemplary embodiment(s) of the present disclosure are merely illustrative in nature, and are in no way intended to limit the present disclosure, its application and/or its uses.

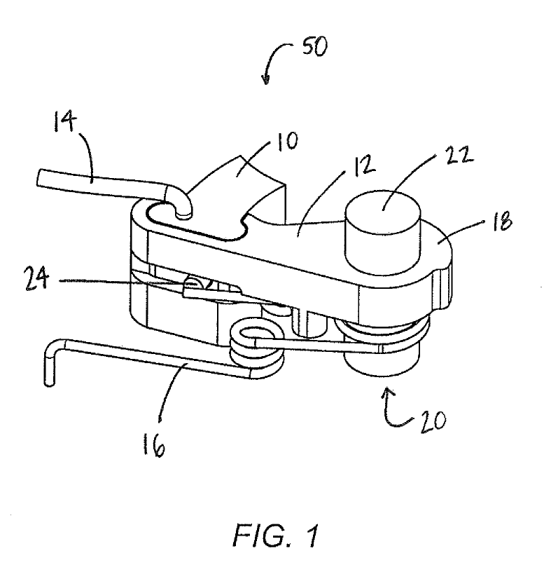

Referring to FIG. 1, an exemplary brush assembly 50 according to the present disclosure is illustrated. The brush assembly 50 includes an arc-shaped brush 10 mounted to pivot arm 12, with a wire 14 attached near the base of the brush 10. The single spring 16 is shown, with one end of the spring visible for mounting in the motor assembly, while the other end (not shown in FIG. 1) leads through a hole in the pivot arm 12 and into the arc-shaped brush 10, and is attached to the interrupter device 24 (not shown in FIG. 1). FIG. 1 also shows a shelf 18, which slides beneath the hold-down tab 26 (not shown in FIG. 1) when the brush assembly is placed in its final position. The slot 20 mates with a shaft 28 (not shown in FIG. 1), which is installed within the motor housing (not shown in FIG. 1).

An example of the geometrically improved arc-shaped brush 10 is also shown in FIG. 1. The disclosed brush 10 can be mounted to the pivot arm 12 in a variety of ways. The exemplary arc-shaped brush 10 shown in FIG. 1 also includes a wire 14 protruding from brush 10, for direct or indirect electrical connection with the power source of an electric motor. The wire 14 is generally fabricated from copper, aluminum or other conducting material; one end of wire 14 is physically bound to the arc-shaped brush 10 by any suitable means, while the other end of wire 14 is adapted for quick electrical connection and disconnection, e.g., through alligator clips or other apparatus which are well known and readily available. Likewise, the arc-shaped brush 10 itself can be affixed to the pivot arm 12 by a variety of known means, as will be readily apparent to persons skilled in the art. Finally, the interrupter device 24 is shown as entering the brush 10 through the rear of the pivot arm 12.

The pivot arm 12 shown in FIG. 1 is made of a non-conductive material, preferably a molded plastic material or composite combination of plastics. Additionally, the pivot arm 12 is fabricated from a material that can resist the high temperature conditions which are present inside the motor housing during motor operation. The disclosed pivot arm 12 is manufactured or molded to include various design features to facilitate the advantageous operation and use disclosed herein, including a shelf 18, a slot 20, and a cap 22. Of note, the pivot arm 12 and brush 10 may be manufactured independently and then bound together; alternatively, the pivot arm 12 may be molded around the arc-shaped brush 1 and assembled concurrently.

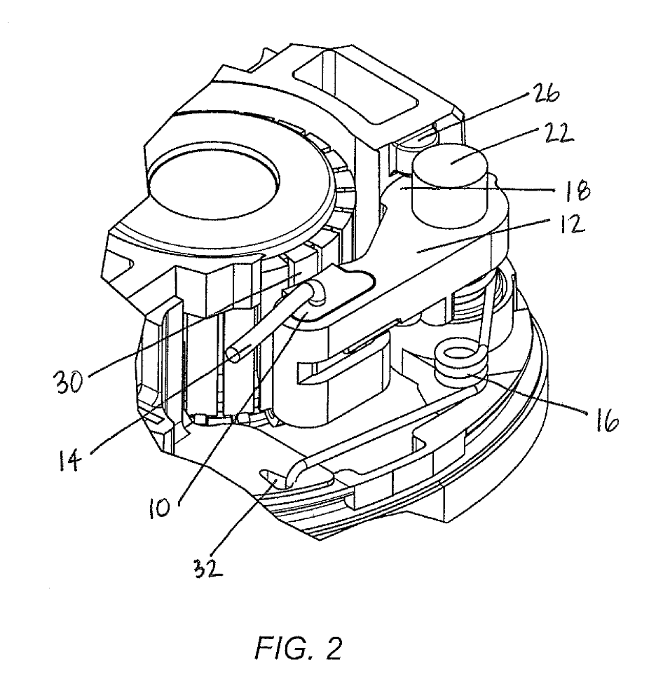

With reference to FIG. 2, an exemplary subassembly of the present disclosure is shown installed in an electric motor housing. The arc-shaped brush 10 is shown near the end of its useful life, in contact with the commutator 30. Additionally, the single spring 16 is shown as attached to the motor housing by way of a preinstalled slot 32. Since the brush assembly is appropriately positioned for operation, the shelf 18 is shown located beneath the hold-down tab 26.

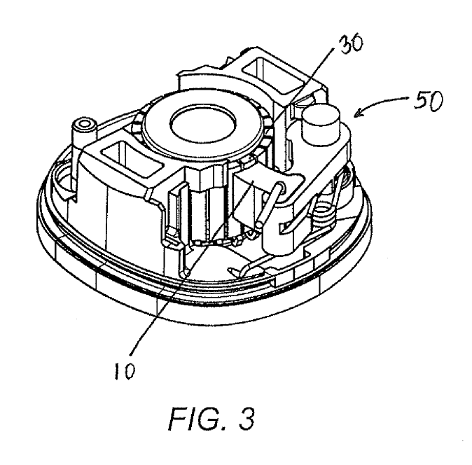

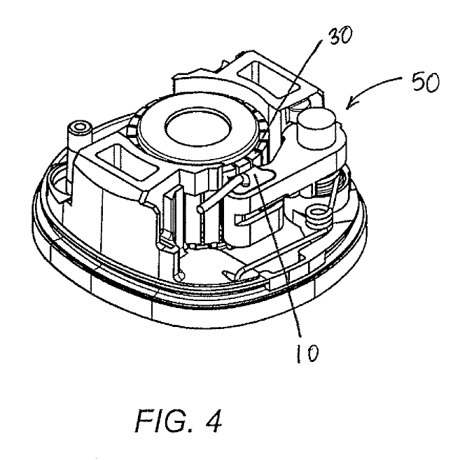

Benefits of the arc shape of brush 10 are demonstrated with reference to FIG. 3 and FIG. 4. FIG. 3 depicts an embodiment of the brush assembly 50 at or near the beginning of the useful life of the arc-shaped brush 10, while FIG. 4 depicts the same brush assembly 50 near the end of the useful life of the arc-shaped brush 10. FIG. 3 and FIG. 4 demonstrate that throughout brush life, the brush face maintains approximately a constant brush face surface area in contact with the rotating commutator 30, despite the substantial wear and reduction in length to the brush, as shown in FIG. 4.

The consistent brush face surface area maintained by the arc-shaped brush 10 of the present disclosure, as shown in FIG. 3 and FIG. 4, provides better conduction between the brush and the commutator and reduces the risk of arcing, sparking or damage to the commutator throughout brush life, as compared to straight-shaped brushes mounted to pivot arms in the prior art.

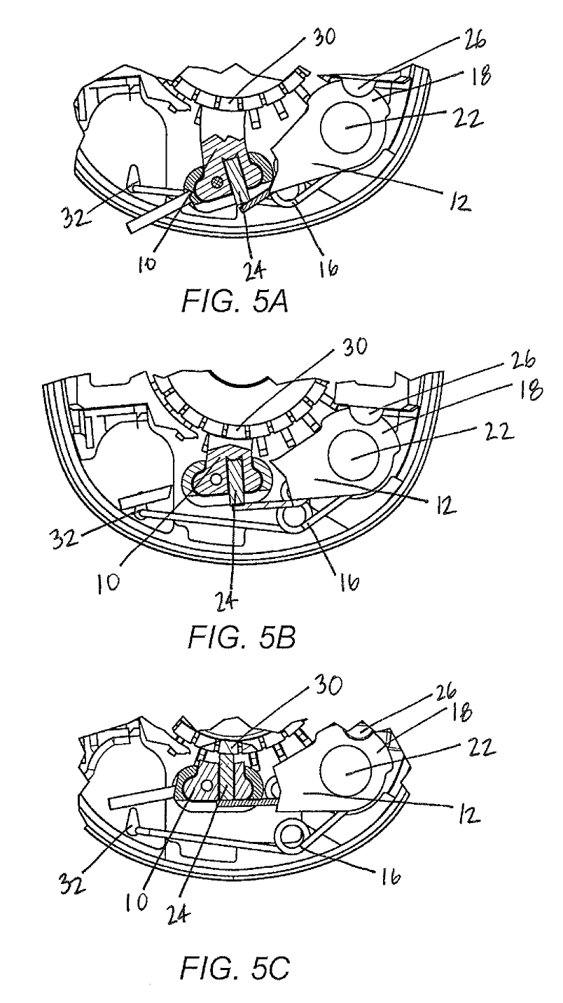

An exemplary interrupter device is shown in FIG. 5A, FIG. 5B and FIG. 5C. With reference to FIG. 5A, a cross-section of a typical arc-shaped brush 10 with an interrupter device 24 is shown, with a plunger embedded in a deployment hole within the brush, and a spring 16 positioned outside the brush 10 providing a biasing force away from the mounting end and toward the operating end of the brush 10. FIG. 5B shows a cross-section of an exemplary arc-shaped brush 10 according to the present disclosure at the moment of device actuation, when the brush 10 has worn to the point where the deployment hole is exposed at the brush face in contact with the rotating commutator 30. FIG. 5C shows a cross-section of an exemplary arc-shaped brush according to the present disclosure after actuation of the interrupter device 24, wherein the biasing spring force applied to the plunger exceeds the biasing spring force maintaining the brush in contact with the commutator, thereby pushing the brush face away from the rotating commutator. This effect opens the electrical circuit between the power source and the armature, and effectively stops the rotation of the rotor.

In exemplary embodiments of the present disclosure, the interrupter device 24 includes a non-conductive tip that is attached to or otherwise in physical communication with the single spring, as is described above. However, the present disclosure is not limited to brush assemblies that include interrupter devices with non-conductive tips. Indeed, the present disclosure extends to and encompasses other devices that are effective to halt a motor's rotation, as will be apparent to persons skilled in the art. Accordingly, the description of an exemplary interrupter device as set forth herein is for illustration purposes only, and is not limiting with respect to the scope of the present disclosure.

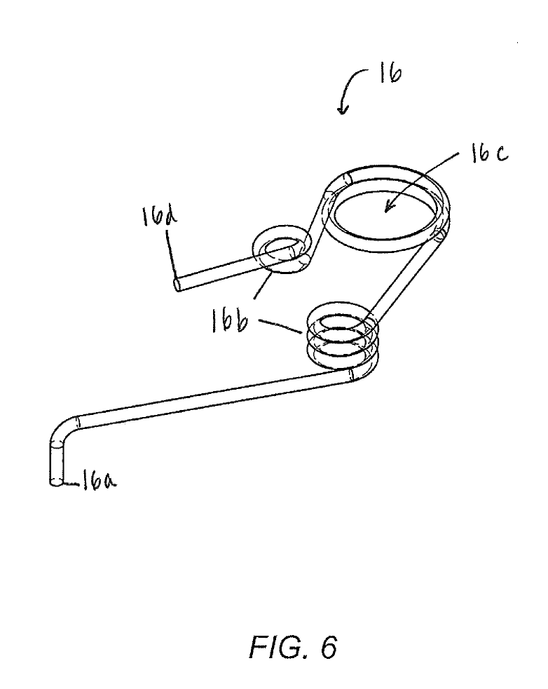

FIG. 6 shows an example of a single spring 16 for use in the brush assemblies of the present disclosure. Tip 16a is exposed for connection to motor housings, and various bends or cants 16b are included as required to create the necessary bias to maintain the brush face in contact with the rotating commutator, and to enable the interrupter device to halt rotation during operation. Loop 16c advantageously wraps around the mated connection between the slot and shaft, while end 16d is generally mounted with respect to an interrupter device. However, the present disclosure is not limited to spring geometries or hole locations such as those that are shown in FIG. 1 and/or FIG. 6. For example, the spring may pass above, below, around or within the pivot arm, so long as the spring provides sufficient bias to the interrupter device to actuate it and provide sufficient force upon contact with the rotating faces of the commutator, i.e., when wear on the brush reaches the limit defined by the depth of the deployment hole.

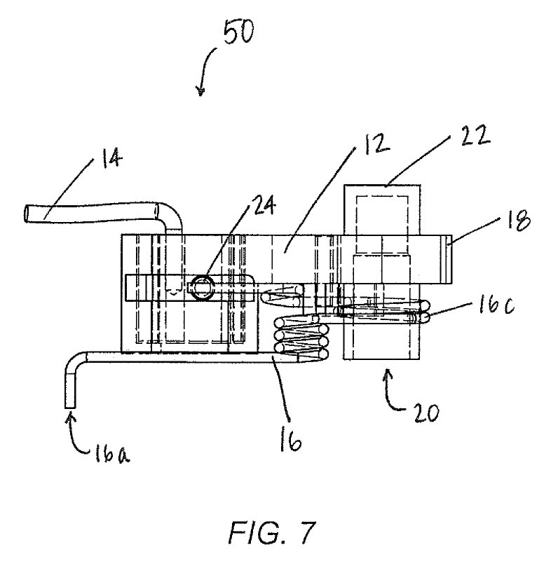

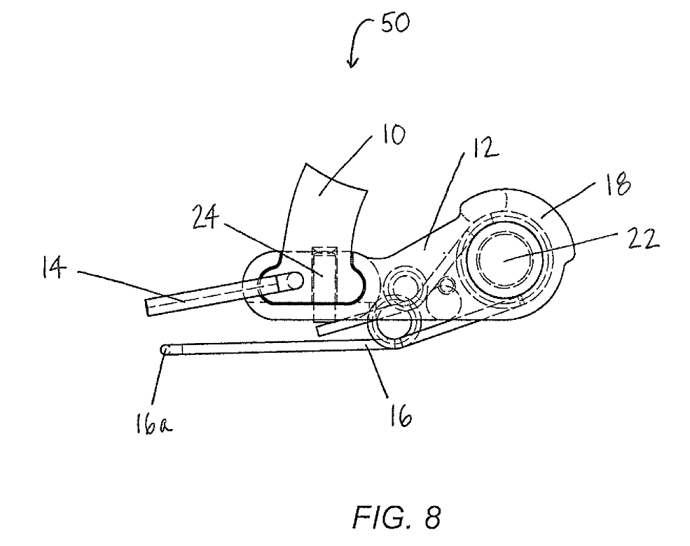

With reference to FIG. 7, a side view of an exemplary brush assembly according to the present disclosure is provided. More particularly, FIG. 7 depicts the relationship between an exemplary biasing spring 16, interrupter device 24 and pivot arm 12, along with the relationship between shaft 28 (not shown in FIG. 7) and the cylindrical slot 20. The end of spring 16a, which is to be mechanically connected to the motor housing, is also shown. FIG. 8 is a top view of the same exemplary embodiment shown in FIG. 7, and shows the arc-shaped brush 10 mounted with respect to pivot arm 12.

According to the present disclosure, the biasing spring force applied to the interrupter device must be sufficient to press the brush face away from the rotating commutator. Therefore, this biasing force must exceed the biasing spring force maintaining the brush face in contact with the commutator. While the present invention is not limited to any particular excess biasing spring force on the interrupter device, or any ratio between the two biasing spring forces, the biasing spring force on the interrupter device in the preferred embodiment is approximately twice the biasing spring force that maintains the pivot arm in contact with the rotating commutator.

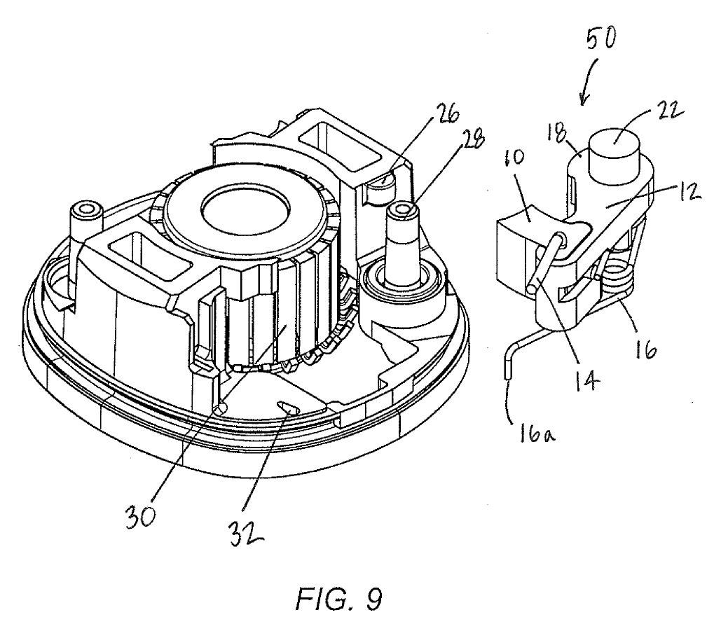

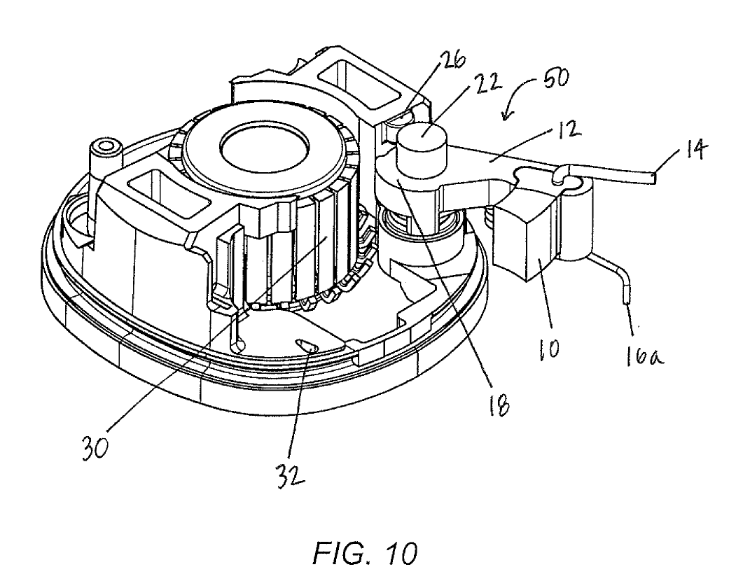

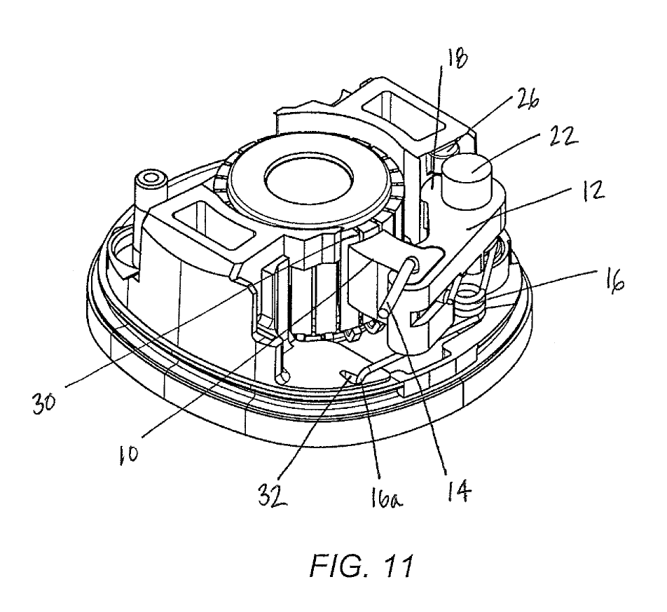

The installation of a brush assembly of the present disclosure into a motor housing is depicted in FIG. 9, FIG. 10 and FIG. 11. With reference to FIG. 9, a preferred embodiment of the brush assembly 50 is shown in the vicinity of a motor housing. A shaft 28 is prefabricated within (or is otherwise mounted with respect to) the motor housing, and is parallel (or substantially parallel) to the rotor's axis.

During installation, the brush assembly 50 is positioned such that the male shaft 28 of the motor housing is aligned for insertion into the brush assembly's female cylindrical slot (not shown in FIG. 9). The brush assembly 50 must be oriented such that its pivot arm 12 extends substantially radially outward from the rotor's axis, so that the shelf 18 of the brush assembly 50 does not contact the hold-down tab 26 of the motor housing upon insertion of the shaft 28 into the cylindrical slot (not shown in FIG. 9). The brush assembly 50 is then slidably positioned onto the male shaft 28, such that the male shaft 28 is inserted into the female cylindrical slot (not shown in FIG. 9) of the pivot arm 12. FIG. 10 depicts a preferred embodiment of the brush assembly 50 extending substantially radially outward from the rotor's axis after the shaft (not shown in FIG. 10) has been inserted into the cylindrical slot (not shown in FIG. 10) of the pivot arm 12, and the brush assembly 50 has been slidably positioned onto the shaft 28.

Next, the brush assembly 50 is placed into the operating position by pivoting the pivot arm 12 about the shaft 28, until the face of the brush 10 is placed into contact with the commutator 30, and the shelf 18 is situated beneath the hold-down tab 26. The end 16a of the single spring 16 is then physically connected to the motor housing, and the wire 14 is electrically connected to the power supply in the motor housing. FIG. 11 depicts a preferred embodiment of the brush assembly 50 in the operating position, with the single spring 16 physically connected to the motor housing by way of a slot 32. In this position, the brush assembly 50 is laterally constrained within the motor housing by the relationship between the male shaft 28 and the female cylindrical slot 20, and is axially constrained within the motor housing by the relationship between the shelf 18 and the hold-down tab 26, but may pivot about the shaft 28 throughout the useful life of the brush 10.

Although the present disclosure has been described with reference to exemplary embodiments thereof the disclosed designs, assemblies and methods may be embodied and/or implemented in alternative ways without departing from the spirit or scope hereof. Accordingly, the present disclosure expressly encompasses alternative embodiments and implementations that would be readily apparent from those skilled in the art based on the description provided herein.

1. A brush assembly for use with an electric motor, comprising:
at least one brush fabricated from an electrically conductive material and defining a deployment channel;
a pivot arm that is configured and dimensioned to engage an end of the at least one brush, the pivot arm defining a cylindrical slot and a contacting shelf spaced from the engagement with the at least one brush;
an interrupter device positioned within the deployment channel defined by the at least one brush; and
an integral single-unit spring element that is configured and dimensioned (i) to apply a first biasing force with respect to the brush, and (ii) to apply a second biasing force with respect to the interrupter device.

2. The brush assembly as defined in claim 1, wherein said brush is fabricated from carbon.

3. The brush assembly as defined in claim 1, wherein said pivot arm is fabricated from high temperature resistant plastic.

4. The brush assembly as defined in claim 1, wherein said interrupter device includes a non-conductive tip.

5. The brush assembly as defined in claim 1, wherein said interrupter device opens the electrical connection between the at least one brush and the motor rotor, and causes the motor to stop operation.

6. The brush assembly as defined in claim 1, wherein the integral single-unit spring element applies the first biasing force to the pivot arm which translates such first biasing force to the at least one brush.

7. The brush assembly as defined in claim 6, wherein the second biasing force applied by the integral, single-unit spring element to the interrupter device is approximately twice the first biasing force applied by the integral, single-unit spring element to the pivot arm.

8. The brush assembly as defined in claim 1 wherein the at least one brush defines a substantially constant rectangular cross-section.

9. The brush assembly as defined in claim 8, wherein the at least one brush further defines an arcuate shape in the longitudinal direction with an operating end for interaction with a commutator and a mounting end for affixation to the pivot arm.

10. The brush assembly as defined in claim 1, wherein the pivot arm is integrally molded.

11. The brush assembly as defined in claim 1, wherein the pivot arm is mounted in a substantially perpendicular orientation relative to the at least one brush.

12. The brush assembly as defined in claim 1, wherein the interrupter device is aligned along the longitudinal axis of the at least one brush.

13. The brush assembly as defined in claim 1, wherein the first biasing force exerted by the integral, single-unit spring element is sufficient to maintain an operating end of the at least one brush in contact with a commutator.

14. The brush assembly as defined in claim 1, wherein the second biasing force exerted by the integral, single-unit spring element exceeds the first biasing force.

15. The brush assembly as defined in claim 1, wherein the integral single-unit spring element is a wire that is formed to deliver the first and second biasing forces.

16. A method for brush assembly operation, comprising:
(a) mounting a first brush assembly with respect to a commutator, the first brush assembly including (i) at least one brush fabricated from an electrically conductive material and defining a deployment channel; (ii) a pivot arm that is configured and dimensioned to engage an end of the at least one brush, the pivot arm defining a cylindrical slot and a contacting shelf spaced from the engagement with the at least one brush; (iii) an interrupter device positioned within the deployment channel defined by the at least one brush; and (iv) an integral single-unit spring element that is configured and dimensioned to apply a first biasing force with respect to the brush and to apply a second biasing force with respect to the interrupter device;
(b) operating the commutator for a period of time sufficient to wear away the at least one brush such that the interrupter device automatically extends from the at least one brush under the second biasing force, thereby interrupting operation of the commutator; and
(c) replacing the first brush assembly with a second brush assembly that includes the same components as the first brush assembly.
